(19) United States
(12) Patent Application Publication
(10) Pub. No.: US 2014/0036791 A1
(43) Pub. Date: Feb. 6, 2014

(54) WHITE SPACE MOBILE CHANNEL SELECTION BASED ON EXPECTED USAGE

(71) Applicant: AIRITY, INC., Dallas, TX (US)

(72) Inventor: Shoshana Loeb Kornacki, Dallas, TX (US)

(73) Assignee: Airity, Inc., Dallas, TX (US)

(21) Appl. No.: 13/666,000

(22) Filed: Nov. 1, 2012

Related U.S. Application Data
(60) Provisional application No. 61/678,814, filed on Aug. 2, 2012.

(51) Int. Cl. H04W 72/00

(52) U.S. Cl. 370/329

(57) ABSTRACT

In described embodiments, white space channel recommendations are provided to a device in a white space channel allocation environment when the device is either stationary or mobile. The channel recommendation comprises of a prioritized channel list where available channels are ordered as a function of their relative optimal applicability. Once a basic list of white space channels is generated based on simple white space channel availability, a final, recommended and prioritized list is computed by a variety of cooperating optimization modules that take into account other objective and subjective parameters related to the user and device. Such other parameters might include projected usage of the spectrum, projected usage duration, device current and projected location and terrain, a user of the device's plans/calendar, and other projections based on user or device history.

### CROSS-REFERENCE TO RELATED APPLICATIONS

This application claims the benefit of the filing date of U.S. provisional application no, 61/678,814, filed on Aug. 2, 2012, as attorney docket no, 300.311Prov, the teachings of which are incorporated herein by reference.

The subject matter of this application is related to U.S. patent application Ser. No. 12/966,196 filed Dec. 13, 2010, as attorney docket no. 311.002, and U.S. patent application Ser. No. 12/966,279 filed Dec. 13, 2010, as attorney docket no. 311.003, the teachings of both of which are incorporated herein by reference.

### BACKGROUND OF THE INVENTION

1. Field of the Invention

The present invention relates to communications, and, in particular, to allocation of communication channels in the presence of protected communication services in a wireless communication system.

2. Description of the Related Art

TV stations in the United States broadcast over a spectrum of frequencies within the UHF spectrum under licenses granted by the Federal Communications Commission (FCC), with other countries providing TV broadcast services in a similar manner over their own defined sets of government-allocated spectrum. To avoid interference, analog TV stations are spaced apart in frequency, and, since TV signals travel a long way, signals in adjacent areas are separated from each other. The unused portions of the UHF Television (TV) spectrum, commonly known as “white space” represent frequency bands that might be employed by a growing number of network devices for wireless communication channels. These unlicensed devices, (“TV Band Devices” or “TVBDs”) might be allocated frequency bands to operate on these white space channels.

On Nov. 4, 2008 the FCC adopted a set of rules to allow these unlicensed devices to operate in the TV spectrum over a defined set of white spaces. The discussion of the FCC's reasoning for the creation of a new class of device, and the new rules allowing such new class of service, are described in a document, “Second Report and Order and Memorandum and Order,” released by the FCC on Nov. 14, 2008, and another document, “Second Memorandum Opinion And Order,” released by the FCC on Sep. 23, 2010. As indicated by the FCC, low power devices might be permitted to operate in the TV bands on frequencies that are not being used by authorized services, enabling the development and operation of a wide range of new unlicensed wireless communications devices and systems.

However, the FCC mandates that new, unlicensed devices not interfere with the incumbent licensed service providers in the TV bands, such as TV broadcast stations, cable head-end services, and devices such as wireless microphones. Since unlicensed broadband devices share spectrum with broadcast TV and other licensed services, unlicensed broadband devices are required to incorporate a capability to avoid causing harmful interference to licensed services in the TV band. Specifically, an unlicensed device must determine whether a TV channel or portion of a TV channel is unused before it transmits. Fixed and personal/portable TVBDs that do not operate in client mode are required to access a central database system as part of such capability to ensure they do not interfere with TV or other licensed entities. A central database system might be generated, and the process of allocating frequency bands or channels to TVBDs might be accomplished, through a service operated by one or more white space allocation service providers.

Radio channel selection is a known problem for various modes of wireless communication. The device needs to select the optimal channel for the communication. The problem is more prominent for communication devices that use the White Space spectrum where frequency channels are not only scarce resource, but also their availability is highly dynamic and depends on a variety of time dependent parameters. The TVBDs that utilizes these channels receives the available channel list from a White Space (WS) Data Base (WSDB) in order to function seamlessly in this dynamic environment.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a white space (WS) channel allocation system provides a prioritized list of available communication WS channels to one or more television band devices (TVBDs). A WS service provider provides channel and device management to the one or more TVBDs. A WS database i) generates and stores available white space channels by geographic location and ii) generates, based on a TVBD request, a simple WS channel list for the corresponding TVBD. A channel availability and assignment module (CAAM stores WS channel configuration information for WS channels of the WS database and provide and provides an available WS channels list from the simple WS channel list based on associated WS channel configuration information. A channel recommendation module processes the available WS channels list into a prioritized list of available WS channels based on expected usage of the TVBD associated with the TVBD request. The WS database, the WS service provider, the one or more TVBDs, the CAAM and the channel recommendation module are coupled and in communication with each other through a network.

In another embodiment, a channel recommendation module for a white space channel allocation system generates a prioritized channel list of available WS channels for a television band device (TVBD). An inferences/reasoning engine generates usage predictions for the TVBD based on user characteristic information, the user characteristic information including at least one of user history, user calendar, user applications, user location, user movement, and user input of the user and the usage associated with the TVBD A prioritization engine generates a preliminary prioritized channel list based on an available WS channels list, WS channel configuration information and the usage predictions; and a global optimization engine adjusts the preliminary prioritized channel list into a final prioritized channel list based on network factors of the WS channel allocation system.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an exemplary white space channel allocation system including channel recommendation;

FIG. 2 shows an exemplary channel recommendation module as might be employed with the white space channel allocation system of FIG. 1; and

FIG. 3 shows an exemplary method of generating a prioritized channel recommendation list.

### DETAILED DESCRIPTION

In described embodiments, white space channel recommendations are provided to a device in a white space channel allocation environment when the device is either stationary or mobile. The channel recommendation comprises a prioritized channel list where available channels are ordered as a function of their relative optimal applicability. Once a basic list of white space channels is generated based on simple white space channel availability, a final, recommended and prioritized list is computed by a variety of cooperating optimization modules that take into account other objective and subjective parameters related to the user and device. Such other parameters might include projected usage of the spectrum, projected usage duration, device current and projected location and terrain, a user of the device's plans/calendar, and other projections based on user or device history.

Embodiments might provide for the following advantages. By “tailoring” channel allocation to a user device accounting for objective and subjective parameters related to the user and device, the user/device might be allocated sufficient bandwidth for service, while retaining more bandwidth in chattels for other users. Further, the user/device might see a higher Quality of Service (QoS) provisioning, and less likelihood of allocated channels being dropped, and so, dropping of service.

As employed herein, the terms “device”, “user device” and TV band device (TVBD) might used interchangeably.

The chattel recommendation system for white space chattel recommendations described herein prioritizes by utilizing some information about the user and the user history to recommend spectrum channels. In particular, since channels are a finite resource (unlike electronic copies of movies or even physical books residing in very large distributed inventories), optimization across users might be performed so that the overall user's community receives a globally optimized service. Furthermore, since the devices are static, mobile, or both, emphasis or other forms of weighting might be applied as part of the optimized recommendation to the user's TVBD's predicted future needs.

Some examples of use include a user traveling through a mostly rural area as a passenger in a moving vehicle and wishes to watch a streaming movie on his device. The channel recommendation system takes into consideration the available channels where the user is located now and using his calendar or other information sources has a sense of where he is headed for the duration of the movie. Using this information as well as available information of no mal usage pattern in the area, the optimally prioritized channel list is offered to the device which either picks an option automatically or allows the user to pick it manually. Another example includes a user that uses the TVBD device to listen to music or stream live radio while pursuing a daily commute on a train that is traveling between two heavily populated urban destinations. Since this user's behavior is part of a usual weekday pattern, the channel recommendation system picks the appropriate channel list which it prioritizes based on QoS and coverage experienced in the past by the user as well as by other users that use similar devices and applications.

In yet another example, the user has no specifically defined pattern for daytime activity. The first time the channel recommendation system offers the device a settable default channel, such as one with the highest bandwidth or one that people fitting his demographics and device seemed to experience the most. However, over time, if the user pattern shows that daytime activity is mostly limited to phone call traffic that is not being adequately served on other existing channels, the channel recommendation system adapts and optimizes that user's profile and selects the optimal channel list appropriately.

The recommended channel list is computed by inferences/reasoning, local prioritization and global optimization that take into account parameters such as the projected usage of the spectrum (e.g., type of device, type of application (e.g., video, email, voice), the projected usage duration, the device location and terrain and projected location and terrain, current and projected utilization of the spectrum) which can be derived from the types of applications being used or are planned to be used by the device, and the like.

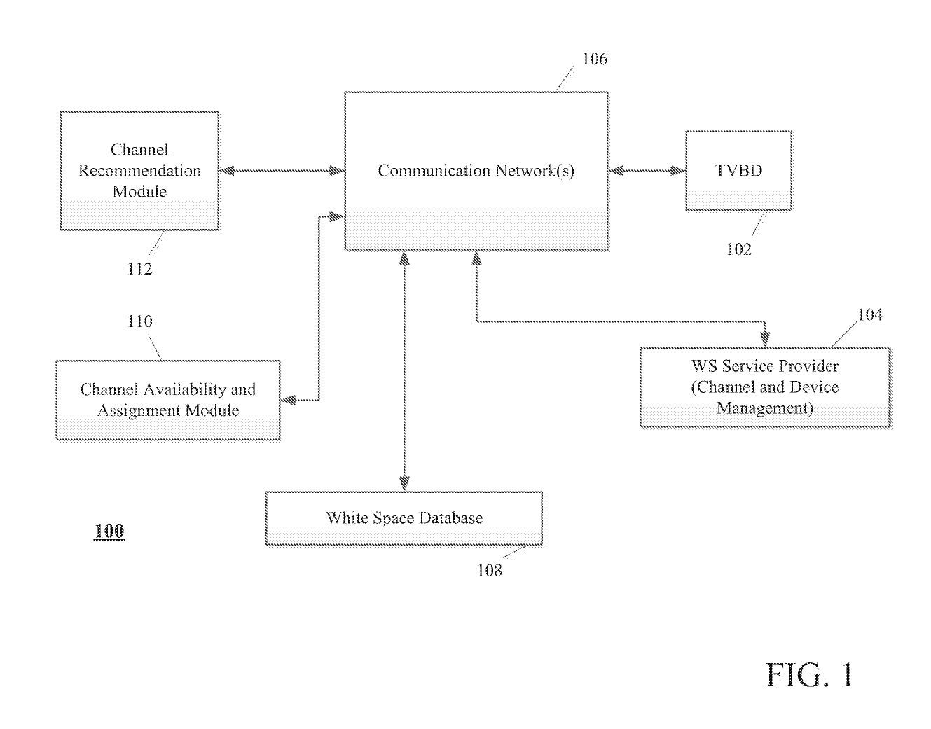

FIG. 1 shows an exemplary white space (WS) channel allocation system 100 including channel recommendation in accordance with exemplary embodiments of the present invention. WS channel allocation system 100 includes TV band device (TVBD) 102 coupled to WS service provider 104 through Communication Network(s) (CommNet) 106. WS channel allocation system 100 further includes WS Database (WSdb) 108, Channel Availability and Assignment module (CAAM) 110 and channel recommendation module 112 further coupled through CommNet 106.

As shown, CommNet 106 represents varying forms of connectivity between the various elements shown in FIG. 1. Since each of the modules may be in various locations, or may be under supervision of different entities, the modules might communicate information through various dedicated public and/or private communication networks. Such communication might be through wired, wireless or optical networks, and might employ packet or other forms of data protocols, such as with the widely known Internet and more recent cloud computing environments. Therefore, CommNet 106 is shown as enabling communication paths between elements under numerous techniques known in the art. Further, while not shown in the Figures, various elements are assumed to include circuitry designed to enable such communication.

TVBD 102 is coupled to WS service provider 104 which provides communication services, so WS service provider 104 provides general channel and device functionality to TVBD 102 as well as to other TVBDs under the control of WS service provider 104. TVBD 102 is either a mobile or static device under control of a corresponding user. General channel and device functionality includes voice/data communication set-up, establishing connectivity of TVBD 102 to desired endpoints, security, billing functions and the like. Of interest herein, general channel and device functionality includes negotiating for, reserving, establishing, monitoring, and transitioning between frequency hands within the WS channel allocation environment that TVBD 102 employs for communication.

Consequently, WS service provider 104 and TVBD 102 employ prioritized sets of WS channels identified through interfaces with WSdb 108. As described subsequently, such prioritized sets are generated in concert with Channel Availability and Assignment module (CAAM) 110 and channel recommendation module 112. Simple WS channel lists (e.g., basically, all channels that might be available for use in a given TVBD device's location) are generated by WSdb 108.

Simple WS channel lists (lists of available WS channels in a given location) and the determination thereof, is a function specified through governmental (e.g., FCC) regulation by administrators of each WS database, such as WSdb 108. Such functions are described in detail in U.S. patent application Ser. No. 12/966,196 filed Dec. 13, 2010, as attorney docket no. 311.002, and U.S. patent application Ser. No. 12/966,279 filed Dec. 13, 2010, as attorney docket no. 311.003, the teachings of both of which are incorporated herein by reference. Consequently, a detailed description of generating the simple WS channel lists is omitted herein.

Since multiple TVBDs serviced by WS service provider 104 might operate within an area, and might have service that might overlap, channels actually employed by each TVBD must be selected and assigned carefully to avoid interference between operating TVBDs. Further, TVBDs of multiple service providers might exist and be co-located, increasing the likelihood of interference. In addition, WS channels represent physical radio channels that might exist in an area, but these physical radio channels have transmission characteristics which are important to determining if reliable communication can be established through the corresponding physical radio channel. Actual channel measurements might show that certain channels have better propagation, others might have high levels of in-band noise, and still others might exhibit multipath or unwanted fading, CAAM 110 represents logical processing and database functions that track channels available for use, channels in use, channels that are released, channels that should be reserved, and channel characteristics depending on, for example, QoS specifications. Such administration of channels is a necessary component of any multiple access communication system, as is known in the art. WS service provider 104 might access CAAM 110 as part of the process to generate one or more actual WS channel lists for use by TVBD 102.

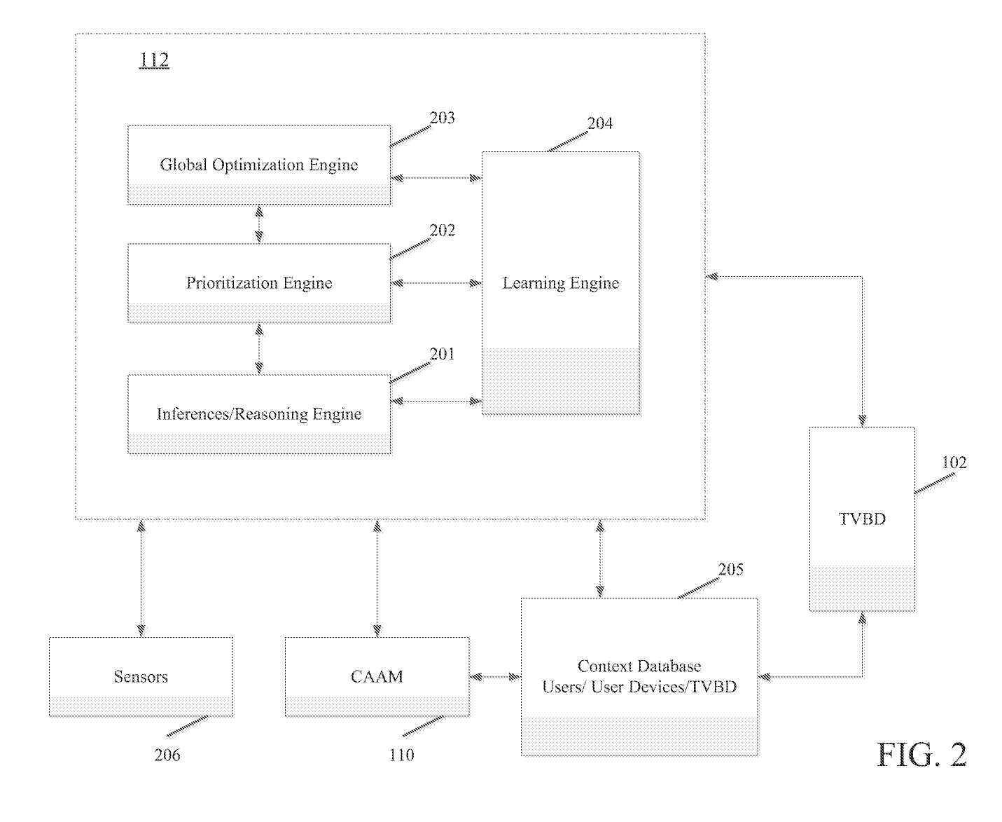

With one or more actual WS channel lists of CAAM 110 for use by TVBD 102, this subset of the Simple WS channel lists might farther be optimized via operation of channel recommendation module 112. Channel recommendation module 112 formulates a final, optimally prioritized channel list which is sent out to TVBD 102. The optimization is based on a large set of criteria and algorithms, as described subsequently with respect to FIG. 2. Furthermore, channel recommendation module 112 may include local information stored about the users/devices it serves, their history and behavior for cases when the user/device operates independently of the TV white space data base channel allocation system, either by a third party or local to the individual device.

FIG. 2 shows an exemplary channel recommendation module 112 as might be employed with the white space channel allocation system of FIG. 1. Channel recommendation module 112 might receive an available channel list (e.g., through CAAM 110), and also receive various sources of additional information from external sensors 206 and from context database 205 to produce a relatively optimal prioritized channel list for the TVBD device (e.g., TVBD 102). External sensors 206 might provide physical or other external information related to current and predicted locations of the user/TVBD. Channel recommendation module 112 processes several pieces of quantitative data relating to channel quality and desirability, and then picks an optimal ordering of channel desirability for a white space service user based on an local and global optimization functions taking into account all available data about the user and the device.

Channel recommendation module 112 comprises inference/reasoning engine 201, prioritization engine 202, global optimization engine 203, and learning engine 204. Functions of these engines are now described.

Inference reasoning engine 201 applies a set of algorithms such as known in the art to process the various available types of information related to the channel recommendation task based on predefined rules. For example, if the user indicates plans to watch a movie, inference/reasoning engine 201 uses knowledge about the available channels and their associated QoS to evaluate their fit for this purpose. If the weather is had and the traffic moves slowly, inference/reasoning engine 201 figures out the implication of channel availability and quality using prior knowledge. The knowledge can be represented as inference rules (e.g., situation—action rules) executed on available inputs to derive outcomes. For example, a rule could say, if the weather conditions are bad and it is the day before Thanksgiving, then car traffic density will be high. This will trigger another rule that could say, if car traffic density is high, spectrum resources will be strained and require extra optimization efforts.

The knowledge can also be represented as knowledge structures (e.g., frames, scripts, schemas), which are information records, that specify among other things, situations, their associated intentions and actions and their properties. For the example above, if the information is represented in a knowledge structure rather than as rules, the structure might be “Holiday traffic” specifying knowledge about traffic during a holiday season and then a sub-structure which indicates what to expect during bad weather, forming the same conclusion as above, information (historic sensor data, device behaviors, inferences, knowledge structures, rules, etc.) can be stored in databases (e.g., SQL) or as large semi structured datasets (e.g., Hadoop). The information available to inference/reasoning engine 201 includes but is not limited to the following.

Location of device served (e.g., current and predicted location of the device) can be obtained using a variety of existing methods including Inverse of the distance to a White Space Access Point belonging to a telecom service associated with the database (if the database were to provide wireless access over the White Space spectrum) or to any other device the white space database intends to communicate with. Predicting the device location can be performed using the direction and speed of the device and the current location at the time the device requested a channel list. Many known techniques exist in the art that determine a device location from radio signals and, for example, global positioning system (GPS) information, but the present invention is not limited thereto. The prediction mild be obtained by data mining information provided voluntarily by the user, or from direct user input as to preferences about activity over time or at the specific time of use, and the like.

Location of other devices in the area (e.g., the actual current location of devices, which might be a function that typically only the service provider or the white space database can provide, is a global view on the utilization of the spectrum resource. Predicted locations of other mobile devices in the area based on a motion model can be performed by obtaining the current location information from white space database administrators and by applying the motion model.

General and contextual information might include: Time of day, Day of week, Date Season, Weather and weather forecast, Past, current and predicted traffic conditions, Special events (big football game nearby, Mother's Day, etc.), Channel Request history for the same type of device or the very device itself, and the like. Such information might be gathered and stored in context database 205.

Available spectrum resources, as described earlier with respect to CAAM 110, might be computed by the white space database administration or another system that has a global view of the spectrum utilization and is typically inversely proportionate to the number and/or density of devices currently present in the vicinity of the device and communicating on this very channel and/or channels directly adjacent to it. Such information is typically employed to minimize potential interference and maximize potential average throughput.

Applications on the device itself (e.g., applications running on TVBD 102) might provide useful information to predict user/user device behavior or plans. This includes the list of active applications on the device as well as, if known, applications used (e.g., watch a movie, speak on the phone). This information can be provided directly by the user or be inferred from information recorded and provided directly by the device. Personalized user information might also be obtained from the device itself such as, but not limited to, User's calendar and User's to-do list.

Prioritization engine 202 performs the local prioritization of the available channels based on the needs of the individual device (e.g. TVBD 102). Channels that are desirable from one perspective (for example, lowest noise) may not be optimal from other perspectives (for example, lack of geographical coverage). Prioritization engine 202 considers relevant for a given TVBD's WS channel request from various perspectives, as determined by inference/reasoning engine 201, based on a given set of user and device requirements. The prioritization might use algorithms that attribute different weights to different factors and parameters, which weights cart be learned or pre-stored.

Global optimization engine 203 performs global optimization of the local prioritization of the available channels to form a final, prioritized list of channels to recommend to TVBD 102 based on the current and projected needs of all the devices that are visible to the system. Learning engine 204 is employed to monitor the activity and results of inference/reasoning engine 201, prioritization engine 202, and global optimization engine 203. From such monitoring, channel recommendation module 112 might determine when decisions and/or predictions work toward or away from correct predictions and optimal performance. When necessary, learning engine might adjust operation of one or more of inference/reasoning engine 201, prioritization engine 202, and global optimization engine 203 to better performance.

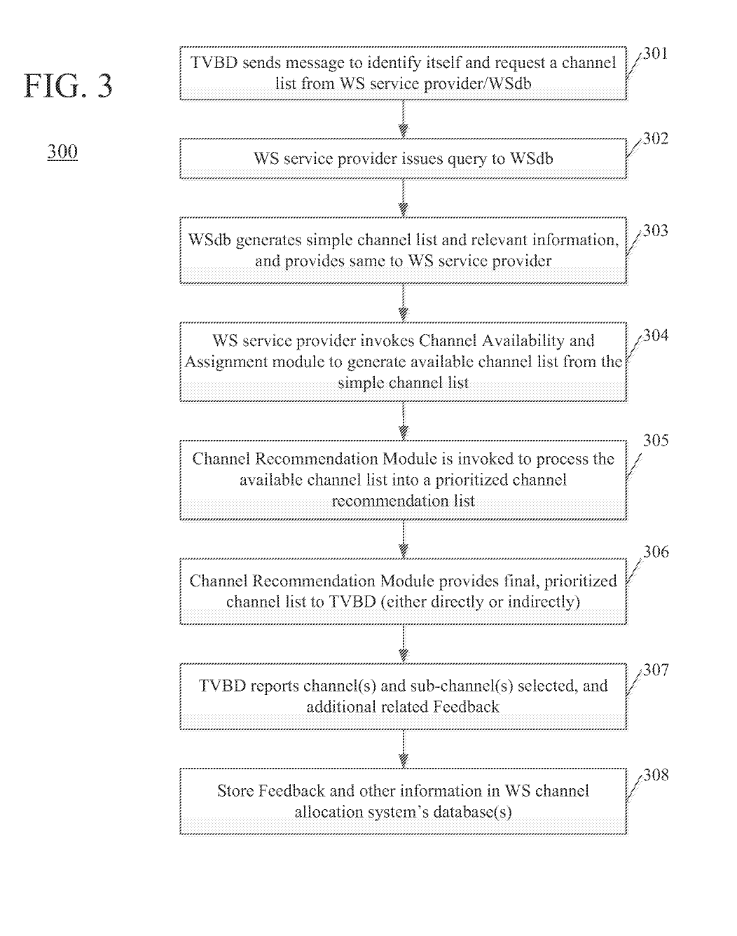

FIG. 3 shows an exemplary method of generating a prioritized channel recommendation list. Referring to FIG. 3, at step 301, the device (e.g., TVBD 102) sends a message to the “channel and device management” component of WS service provider 104 coupled to WSdb 108 to identify itself and request a channel list. TVBD 102 provides a string, or a number, or a combination of both that can be used by the to space database processing to determine device type. For example numbers such as the following might be sent: MAC address, part number, serial number, FCC ID, unique user ID, and the like. TVBD 102 also provides the channel device management component of WS service provider 104 all available context information such as location, application being used or planned to be used, and the like. At step 302, WS service provider 104 issues a query to the TV white space database about the device type, its past behavior, past behavior of similar devices and the like.

At step 303, WSdb 108 generates and/or retrieves the relevant available information and provides the simple WS channel list to WS service provider 104. At step 304, WS service provider 104 invokes CAAM 110 to generate the available channels to allocate based on the simple list as described previously. Once the list of available channels is ready either CAAM 110 or WS service provider 104 sends the list of available channels to channel recommendation module 112 for prioritization together with all the available context and projection information.

At step 305, channel recommendation module 112 is invoked to process the available channel list as well as other available information about the device, the context (including, for example, current and projected location, and usage of network resources). Channel recommendation module 112 produces a prioritized channel recommendation list. At step 306, the final, (optimally) prioritized channel list is provided to TVBD 102.

At step 307, TVBD 102 reports what channel and sub-channel (if applicable) it uses WSdb 108 and WS service provider 104 as well as other feedback information including quality of service from which the learning engine of channel recommendation module 112 may compute “lessons learned”. At step 308, the feedback is stored in the database.

Having described basic operation of WS channel allocation system 100 with respect to FIGS. 1, 2 and 3, one skilled in the art might realize that the various functions might be implemented by various entities. By way of example, operation of FIGS. 1, 2 and 3 for three different entity structures, defined as use-case 1 through use-case 3, are now described.

In use-case 1, the TV white space database infrastructure provides the channel recommendations as a prioritized channel list to the TVBD device. For example, in use-case 1. WS service provider 104 uses WSdb 108, CAAM 110 and channel recommendation module 112 operating as a combined and integrated system. Use-case 1 provides the advantage that the channel recommendation functionality via the service provider and WS database administration has a complete global view on the network and the devices, which can be used for globally optimizing the WS channel recommendations. For use-case 1, the TVBD device's user must provide varying amounts of user/user device information, raising requirements for enhanced system privacy and security.

In use-case 2, a third party recommender system provides the prioritized channel list to the TVBD device based on information from the white space channel database and other data sources. In use-case 2, channel recommendation module 112 is implemented by a third party that accesses but is separate from TVBD 102 and WSdb 108 (but might be associated with CAAM 110 and WS service provider 104). In use-case 2, the white space channel recommendation functionality is offered by a third party that is not associated with the white space database infrastructure. This third party might be an independent business that offers the channel recommendation functionality as a service on a subscription basis or on-demand. This third party might even serve as a single point of contact between the device and the channel database(s), in effect serving as a mediator between the user's TVBD device and the database. This use-case 2 provides the advantage that multiple vendors can offer the channel recommendation functionality competitively and, hence, the quality of service may be enhanced while prices for the service may be driven down due to competition. User privacy or perceived privacy may be threatened if detailed information about the device context and user's applications is communicated out of the device. The channel recommendation functionality may not employ a complete global view on the network and the devices for use by a globally optimization engine.

in use-case 3, the functions of the recommender system are provided within the TVBD device itself (e.g., channel recommendation module 112 is integrated into TVBD device 102), generating the prioritized channel list based on information from the white space channel database and other data sources. In use-case 3, the channel recommendation functionality resides on the user's TVBD device itself, with direct access to a user's applications, activities and calendar without privacy concerns. The device may not have global information about overall resource utilization and project use from other users unless this information will be provided to it by the white space database infrastructure.

Use-case 3 might provide enhanced performance through scalability and privacy, since more functions are performed locally at the TVBD device. However, the channel recommendation functionality is the least complete global view on the network and the devices for use by a globally optimization engine. Such functions are also limited by access to computing or other processing power if much of the channel recommendation functionality is performed on the TVBD device, especially if processing very large amounts of information in real-time.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention. Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

No claim element herein is to be construed under the provisions of 35 U.S.C. §112, sixth paragraph, unless the element is expressly recited using the phrase “means for” or “step for.”

It is understood that various changes in the details, materials, and arrangements of the parts which have been described and illustrated in order to explain the nature of this invention may be made by those skilled in the art without departing from the scope of the embodiments of the invention as encompassed in the following claims.

We claim:

1. A white space (WS) channel allocation system for providing a prioritized list of available communication WS channels to one or more television band devices (TVBDs), comprising:
a WS service provider configured to provide channel and device management to the one or more TVBDs;
a WS database configured to i) generate and store available white space channels by geographic location and ii) generate, based on a TVBD request, a simple WS channel list for the corresponding TVBD;
a channel availability and assignment module (CAAM) configured to store WS channel configuration information for WS channels of the WS database and provide and provide an available WS channels list from the simple WS channel list based on associated WS channel configuration information; and
a channel recommendation module configured to process the available WS channels list into a prioritized list of available WS channels based on expected usage of the TVBD associated with the TVBD request,
wherein the WS database, the WS service provider, the one or more TVBDs, the CAAM and the channel recommendation module are coupled and in communication with each other through a network.

2. The invention of claim 1, wherein the WS channel configuration information includes TVBD WS channel assignments/status, WS physical channel characteristics, and WS channel use information.

3. The invention of claim 1, wherein the expected usage of the TVBD is derived from at least one of user history, user calendar, user applications, user location, user movement, and user input of the user and the usage associated with the TVBD.

4. The invention of claim 1, wherein the channel recommendation module comprises:
an inferences/reasoning engine configured to generate usage predictions for a TVBD based on user characteristic information, the user characteristic information including at least one of user history, user calendar, user applications, user location, user movement, and user input of the user and the usage associated with the TVBD
a prioritization engine configured to generate a preliminary prioritized channel list based on an available WS channels list, WS channel configuration information and the usage predictions; and
a global optimization engine configured to adjust the preliminary prioritized channel list into a final prioritized channel list based on network factors of the WS channel allocation system.

5. The invention of claim 4, wherein the channel recommendation module farther comprises a learning engine, the learning engine configured to update operation of, based on past operation of, the inferences/reasoning engine, the prioritization engine, and the global optimization engine.

6. The invention of claim 5, wherein the learning engine of the channel recommendation module is coupled with a context database, the context database configured to store and provide context information for one or more TVBDs and users of the one or more TVBDs.

7. The invention of claim 1, wherein the TVBD is a mobile device.

8. A channel recommendation module for a white space channel allocation system, comprising:
an inferences/reasoning engine configured to generate usage predictions for a television band device (TVBD) based on user characteristic information, the user characteristic information including at least one of user history, user calendar, user applications, user location, user movement, and user input of the user and the usage associated with the TVBD;
a prioritization engine configured to generate a preliminary prioritized channel list based on an available WS channels list, WS channel configuration information and the usage predictions; and
a global optimization engine configured to adjust the preliminary prioritized channel list into a final prioritized channel list based on network factors of the WS channel allocation system.

9. The invention of claim 8, wherein the channel recommendation module farther comprises a learning engine, the learning engine configured to update operation of, based on past operation of, the inferences/reasoning engine, the prioritization engine, and the global optimization engine.

10. The invention of claim 8, wherein the learning engine of the channel recommendation module is coupled with a context database, the context database configured to store and provide context information for one or more TVBDs and users of the one or more TVBDs.

11. The invention of claim 8, wherein the channel recommendation module is a component of the TVBD.

12. The invention of claim 8, wherein the channel recommendation module is a component of a channel availability and assignment module (CAAM) coupled with a WS database.

13. The invention of claim 8, wherein the channel recommendation module is coupled with one or more sensors, the one or more sensors providing current network, channel, and TVBD environment information for a WS network served by the WS channel allocation system.

14. The invention of claim 8, wherein at least one of the inferences/reasoning engine, the prioritization engine, and the global optimization engine employ the current network, channel, and TVBD environment information to prioritize the WS channels of the available WS channels list.

15. A method of providing a prioritized list of available communication WS channels to one or more television hand devices (TVBDs) in a white space (WS) channel allocation system, comprising:
providing, by a WS service provider, channel and device management to the one or more TVBDs;
generating, by a WS database, i) available white space channels by geographic location and ii) based on a TVBD request, a simple WS channel list for the corresponding TVBD;
storing, by a channel availability and assignment module (CAAM), WS channel configuration information for WS channels of the WS database and provide and providing an available WS channels list from the simple WS channel list based on associated WS channel configuration information; and
processing, by a channel recommendation module, the available WS channels list into a prioritized list of available WS channels based on expected usage of the TVBD associated with the TVBD request,
wherein the WS database, the WS service provider, the one or more TVBDs, the CAAM and the channel recommendation module are coupled and in communication with each other through a network.

16. The invention of claim 15, wherein the WS channel configuration information includes TVBD WS channel assignments/status, WS physical channel characteristics, and WS channel use information.

17. The invention of claim 15, comprising deriving the expected usage of the TVBD from at least one of user history, user calendar, user applications, user location, user movement, and user input of the user and the usage associated with the TVBD.

18. The invention of claim 15, wherein the processing by the channel recommendation module comprises:
generating, with an inferences/reasoning engine, usage predictions for a TVBD based on user characteristic information, the user characteristic information including at least one of user history, user calendar, user applications, user location, user movement, and user input of the user and the usage associated with the TVBD
generating, by a prioritization engine, a preliminary prioritized channel list based on an available WS channels list, WS channel configuration information and the usage predictions; and
adjusting, by a global optimization engine, the preliminary prioritized channel list into a final prioritized channel list based on network factors of the WS channel allocation system.

19. The invention of claim 18, wherein the channel recommendation module further comprises a learning engine, the learning engine updating operation of, based on past operation of, the inferences/reasoning engine, the prioritization engine, and the global optimization engine.

20. The invention of claim 19, wherein the learning engine of the channel recommendation module is coupled with a context database, the context database storing and providing context information for one or more TVBDs and users of the one or more TVBDs.
